(19) United States
(12) Patent Application Publication
(10) Pub. No.: US 2023/0367848 A1
(43) Pub. Date: Nov. 16, 2023

(54) UNSUPERVISED CHANGED DETECTION USING DENSITY-RATIO ESTIMATION SYSTEM AND METHOD

(71) Applicant: Arizona Board of Regents on Behalf of the University of Arizona, Tucson, AZ (US)

(72) Inventors: Ravi Tandon, Tucson, AZ (US); Mohamed Attia, Tucson, AZ (US); Sudarshan Adiga, Tucson, AZ (US)

(21) Appl. No.: 18/316,138

(22) Filed: May 11, 2023

Related U.S. Application Data
(60) Provisional application No. 63/340,623, filed on May 11, 2022.

(51) Int. Cl. G06F 17/18

(52) U.S. Cl. CPC G06F 17/18

(57) ABSTRACT

An unsupervised density-ratio estimation (DRE) based approach is used to determine statistical changes in time-series data when no knowledge of the pre- and post-change distributions are available. The core idea behind the disclosed technology is to split the time-series at an arbitrary point and estimate the ratio of densities of distribution (using a parametric model such as a neural network) before and after the split point. The DRE-CUSUM change detection statistic is then derived from the cumulative sum (CUSUM) of the logarithm of the estimated density ratio. Theoretical justification as well as accuracy guarantees are provided which show that the proposed statistic can reliably detect statistical changes, irrespective of the split point. The disclosed framework makes it readily applicable in various practical settings (including high-dimensional time-series data).

### CROSS-REFERENCE TO RELATED APPLICATIONS

This application claims the benefit of U.S. Provisional 63/340,623, filed May 11, 2022, which is hereby incorporated by reference in its entirety.

### FEDERAL FUNDING

This invention was made with government support under Grants CAREER 1651492, CNS 1715947, and CCF 2100013 awarded by the National Science Foundation. The government has certain rights in the invention.

### BACKGROUND

### 1. Field of the Invention

The present invention generally relates to the field of data analytics, and more particularly to the field of time series data analytics and the process of detecting changes in time series data, such as changes in video data. In particular, the invention relates to computing devices and systems programmed with software containing time series change detection model(s) developed using the machine learning and other data analytics techniques described herein.

### 2. Background

Generally, change detection is the process of identifying deviations in the statistical behavior of time series data, and finds numerous applications, such as detection of distributed denial of service (DDoS) attacks, real-time surveillance, video segmentation, event prediction, and healthcare monitoring. A deviation in the data might reveal when there is an increase in web traffic being directed to a universal resource locator, or when a person in a video switches from walking to running, or when a motor vehicle or other object is first detected in the field of view of a camera, or when a real-time monitored blood oxygen concentration changes.

It is understood that existing time series data analytical techniques rely on using a statistical maximum likelihood (ML) and cumulative sum (CUSUM) computation, but it is understood that they can only be applied when the density ratio between pre- and post-change point distributions, P1 and P2, occurring at some unknown change point time, T*, can be accurately computed for any time series data X, where X comprises of n points={x1, . . . xn). But, in several real-world applications, the distributions P1 and P2, before and after the change point, respectively, are unknown. Several existing algorithms, such as sequential probability ratio test (SPRT), generalized likelihood ratio test (GLRT), CUSUM and its variants such as weighted CUSUM, are based on the assumption that the density ratios can be readily computed for devising test-statistics for change detection. That assumption, however, renders those techniques impractical for certain applications. Specifically, a computing device or system, such as a computer programmed with software according to the above and other known data analytics techniques, would be expected to perform inadequately when employed in in one of the aforementioned applications. That can present challenges, especially in situations where being alerted to a change occurring in real time or near-real time is important so that a proper responsive action may be undertaken.

What is needed, therefore, is a computing device or system programmed with software embodying an approach for change detection where there is no knowledge about pre- and post-change distributions. The present invention provides for such a computing device or system, and includes software containing one or more time series change detection models developed using the machine learning and other data analytics techniques described here and in the accompanying pre-print paper entitled, “Unsupervised Change Detection using DRE-CUSUM,” by S. Adiga and R. Tandon (“Adiga et al. 2022”), the content of which is incorporated herein in its entirety.

### SUMMARY

In the present disclosure, a computing device or system is provided containing one or more processor-executable time series change detection models. In one embodiment, the computing device may be a desktop or laptop computer used by an individual user. In another embodiment, the computing device may consist of a system of several networked computing devices used by employees across an enterprise each having a version of the software installed therein. In still another embodiment, the system may include software employed as software-as-a-service (SaaS) in a cloud-based solution whereby customers may access the models to perform their own data analytics, paying for use as needed. Other embodiments are also contemplated.

The time series data analytics models of the present disclosure may be developed for example by training one or more suitable learning or statistical algorithms according to the examples set forth in Adiga et al (2022). In one aspect, given a time series X [1:n] with an unknown change point at time T*, the time series data is split at an arbitrarily chosen time, Tₛₚₗᵢₜ (say n/2) to obtain two sub-sequences as P_{left} (the distribution of data X[1:Tₛₚₗᵢₜ−1]), and Plight (the distribution of data X[Tₛₚₗᵢₜ:n]). An unsupervised change detection statistic which mimics the conventional CUSUM statistic, with the difference that P₂(x)/P₁(x) is replaced by the estimate of the density ratio P_{left}(x)/P_{right}(x). It was surprisingly found that in doing so, the density ratio estimation and cumulative sum (DRE-CUSUM) statistic possesses theoretical properties analogous to the conventional CUSUM statistic but that always holds true irrespective of the choice of Tₛₚₗᵢₜ. It was also found that accuracy guarantees may be proven by determining the bounds on the probability of error of the estimated change point, given that the estimator can correctly compute the density ratio with high probability. The theoretical results supporting the use of the DRE-CUSUM statistic for unsupervised change detection do not make any assumptions about the density ratio estimators. Therefore, in practice, one can leverage and choose from a wide variety of known density ratio estimation techniques to estimate P_{left}(.)/P_{right}(.) That allows for a general and efficient framework for unsupervised change detection that is applicable for high-dimensional data. The present DRE-CUSUM approach may be generalized for detecting multiple changes as well as for online change detection.

In one approach, a suitable model may be developed according to the approach shown in Adiga et al (2022) as Algorithm 1. Generally, the process may include:
1. Inputting time-series data: x1, x2, xT*, . . . , xn;
2. Training a density ratio estimator (DRE);
3. Computing a density ratio based cumulative sum of likelihood ratio-based statistic,

$${S}_{DRE}^{{T}_{split}} ( t ) = {\sum }_{i = 1}^{t} log ( \hat{ω} ( x ) ) ;$$

and
4. Listing the time instance (estimated change point) at which there is a change in slope.

### BRIEF DESCRIPTION OF THE FIGURES

For a detailed description of various examples, reference will now be made to the accompanying drawings.

FIG. 1A shows an exemplary plot of time-series data with a single change point in accordance with one or more embodiments of the disclosed technology.

FIG. 1B shows an exemplary plot of density-ration based CUSUM statistic in accordance with one or more embodiments of the disclosed technology.

FIG. 2A shows an exemplary plot of time-series data with multiple change points in accordance with one or more embodiments of the disclosed technology.

FIG. 2B shows an exemplary plot for unsupervised multiple change detection in accordance with one or more embodiments of the disclosed technology.

FIG. 3 shows an online adaptation of DRE-CUSUM algorithm in accordance with one or more embodiments of the disclosed technology.

FIG. 4A shows an exemplary failure mode detection in accordance with one or more embodiments of the disclosed technology.

FIG. 4B shows an exemplary computation of a DRE-CUSUM statistic in accordance with one or more embodiments of the disclosed technology.

FIG. 5A shows robustness of an exemplary DRE-CUSUM algorithm in accordance with one or more embodiments of the disclosed technology.

FIG. 5B shows robustness of another exemplary DRE-CUSUM algorithm in accordance with one or more embodiments of the disclosed technology.

FIG. 6A shows an exemplary process for video event detection using a DRE-CUSUM algorithm in accordance with one or more embodiments of the disclosed technology.

FIG. 6B shows another exemplary process for video event detection using a DRE-CUSUM algorithm in accordance with one or more embodiments of the disclosed technology.

FIG. 7A shows an exemplary plot of regions split into sub-regions in accordance with one or more embodiments of the disclosed technology.

FIG. 7B shows an exemplary plot of sub-intervals of increasing lengths in accordance with one or more embodiments of the disclosed technology.

FIG. 8A shows an exemplary process for video event detection within a pedestrian dataset using a DRE-CUSUM algorithm in accordance with one or more embodiments of the disclosed technology.

FIG. 8B shows an exemplary process for video event detection within an overpass dataset using a DRE-CUSUM algorithm in accordance with one or more embodiments of the disclosed technology.

FIG. 9 shows an exemplary multifunction user device in accordance with one or more embodiments of the disclosed technology.

### DETAILED DESCRIPTION

The present disclosure relates to, inter alia, systems and methods for DRE-CUSUM, an unsupervised density-ratio estimation (DRE) based approach to determine statistical changes in time-series data when no knowledge of the pre- and post-change distributions are available. The core idea behind the disclosed technology is to split the time-series at an arbitrary point and estimate the ratio of densities of distribution (using a parametric model such as a neural network) before and after the split point. The DRE-CUSUM change detection statistic is then derived from the cumulative sum (CUSUM) of the logarithm of the estimated density ratio. Theoretical justification as well as accuracy guarantees are provided which show that the proposed statistic can reliably detect statistical changes, irrespective of the split point. The disclosed framework makes it readily applicable in various practical settings (including high-dimensional time-series data). Additionally, generalizations for online change detection is provided. The disclosed DRE-CUSUM technology may use both synthetic and real-world datasets over existing state-of-the-art unsupervised algorithms (such as Bayesian online change detection, its variants as well as several other heuristic methods).

Change detection is the process of identifying deviations in the statistical behavior of time series data, and finds numerous applications, such as detection of distributed denial of service (DDoS) attacks, real-time surveillance, video segmentation, event prediction, and healthcare monitoring. For the canonical problem of change detection, consider a time-series data, denoted by X_{[1:n]}(x₁, x₂, . . . xₙ) with a single change point at some unknown time T*. Elements of the sub-sequence X_{[1:T*-1]} i.i.d. and sampled from a distribution P₁, whereas the elements of sub-sequence X_{[T*:n]} are sampled from a distribution P₂. The goal of offline change detection is to efficiently determine T*.

When the pre- and post-change distributions P₁, and P₂ are known, one can obtain the maximum-likelihood (ML) estimate for the change point using cumulative-sum (CUSUM) of log-likelihood ratios based statistic, denoted as:

Sₖ=Σₜ₌₀^{k} log(P₂(xₜ)/P₁(xₜ))

The main intuition behind CUSUM statistic stems from the expected values of the log-likelihood ratio P₂(.)/P₁(.), before and after T*, which is

$${𝔼}_{{x}_{t}} log ( \frac{{P}_{2} ( {x}_{t} )}{{P}_{1} ( {x}_{t} )} ) = \{ \begin{matrix}- KL ( {P}_{1} \vert \vert {P}_{2} ) , & t < {T}^{*} \\ KL ( {P}_{2} \vert \vert {P}_{1} ) , & t \geq {T}^{*}\end{matrix} \qquad ( 1 )$$

Since Kullback-Leibler (KL) divergence is non-negative, the CUSUM statistic has a negative expected slope for any t<T*, and conversely, positive expected slope for t≥T*. However, the limitation of the ML- and CUSUM approaches is that they can be applied only when P₂(x)/P₁(x) can be accurately computed for any x. Moreover, in real-world applications the distributions before and after the change point (denoted by P₁, P₂, respectively) are unknown, and hence these approaches are impracticable.

In some embodiments of the disclosed technology, change detection is determined when pre- and post-change distributions is unknown. Further, no assumptions are made on the underlying probability distributions (i.e., a non-parametric setting is used). In some embodiments, the proposed methodology is as follows: observe a time series T_{[i:n]} with an unknown change point at T*. Split the time-series data at an arbitrarily chosen time Tₛₚₗᵢₜ (e.g., n/2) to obtain two sub-sequences as X[1:Tₛₚₗᵢₜ−1]⊇P_{left}, and X[1:Tₛₚₗᵢₜ−n]˜P_{right}. Using DRE-CUSUM, an unsupervised change detection statistic that mimics the conventional CUSUM statistic is provided, with the difference that P₂(x)/P₁(x) is replaced by the estimate of the density ratio P_{left}(x)/P_{right}(x). As a result, the DRE-CUSUM statistic possesses theoretical properties analogous to the conventional CUSUM statistic, by showing that

$${𝔼}_{{x}_{t}} log ( \frac{{P}_{left} ( {x}_{t} )}{{P}_{right} ( {x}_{t} )} ) = \{ \begin{matrix}> 0 , & for t < {T}^{*} \\ < 0 , & for t \geq {T}^{*}\end{matrix} \qquad ( 2 )$$

The highlight of Formula (2) is the fact that it always holds true irrespective of the choice of Tₛₚₗᵢₜ. In addition, accuracy guarantees for DRE-CUSUM are shown by determining the bounds on the probability of error of the estimated change point given that the estimator can correctly compute the density ratio with high probability. Furthermore, the theoretical results supporting the use of DRE-CUSUM statistic for unsupervised change detection do not make any assumptions on the density ratio estimators. Therefore, in practice, one can leverage and choose from a wide variety of density ratio estimation techniques to estimate P_{left}(x)/P_{right}(x). This allows a quite general and efficient framework for unsupervised change detection applicable for high-dimensional data.

In some embodiments, generalization of the DRE-CUSUM approach for detecting multiple changes as well as for online-change detection. For example, possible failure modes of the disclosed technology are provided with methods to overcome the failure modes. Additionally, DRE-CUSUM may be implemented for change detection methods using synthetic, real-world datasets, or combinations or variations thereof.

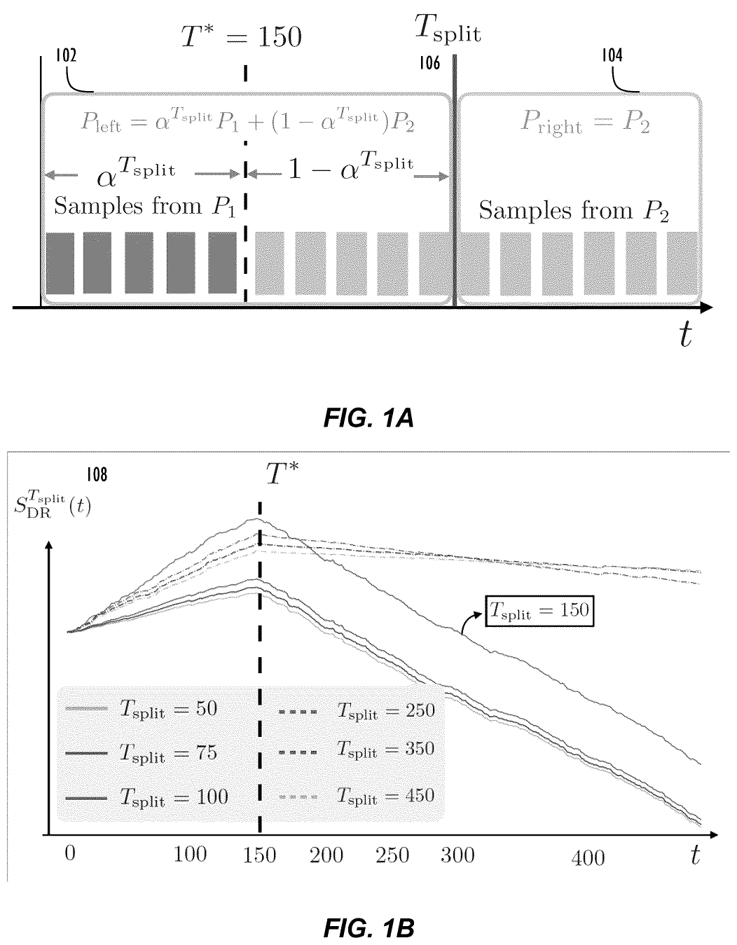

Referring to FIG. 1A, an exemplary plot of time-series data with a single change point is shown as an example for implementing unsupervised change detection. When pre- and post-change distributions are known, one can obtain the change point estimate (TML) using maximum likelihood (ML):

$${\hat{T}}_{ML} = {arg max}_{t} {\sum }_{i = t}^{n} log ( \frac{{P}_{2} ( {x}_{i} )}{{P}_{1} ( {x}_{i} )} ) \qquad ( 3 )$$

The ML approach may be applied if either the distributions P₁ and P₂ are known, or the density ratio P₂/P₁ can be accurately computed. The need for the information on the distributions and their corresponding order in the time series makes the ML approach infeasible for most change detection applications.

In some embodiments, when the pre- and post-change distributions are unknown, a setting is used for a time series at a certain point in time. When a time series is split, two sub-sequences are obtained. In this example, corresponding distributions are shown in FIG. 1A as sub-sequence 102 and sub-sequence 104 based on a relative position of time split 104 with respect to T*. Either 102 or 104 is a mixture distribution and conversely the other is a pure distribution (102 or 104). For example, time-series data is shown with a single change point at T* when Tₛₚₗᵢₜ is >T and yields two distributions, 102 and 104. Density-ratio (DR) may be defined based on a cumulative-sum (CUSUM) of likelihood ratio-based statistic:

$${S}_{DR}^{{T}_{split}} ( t ) , ∀ t ∈ [ 1 , n ] . \qquad ( 4 )$$

$${S}_{DR}^{{T}_{split}} ( t ) {=}^{Δ} {\sum }_{j = 1}^{t} log ( \frac{{P}_{left} ( {x}_{j} )}{{P}_{right} ( {x}_{j} )} ) .$$

FIG. 1B depicts the ratio-based statistic for different values of Tₛₚₗᵢₜ (i.e. both Tₛₚₗᵢₜ≥T* and Tₛₚₗᵢₜ<T*) for a 10-dimensional multivariate Gaussian time-series undergoing a mean change an exemplary plot of density-ration based CUSUM statistic in accordance with one or more embodiments of the disclosed technology. For example, FIG. 1B shows a plot of a density-ratio based CUSUM statistic 108 for 10-dimensional time-series with 500 samples and an unknown change point T*=150. As shown in FIG. 1B, the slope of 108 changes at T* irrespective of the value of Tₛₚₗᵢₜ, at T*=150. As seen from this example, the change point T* manifests itself in 108 through a slope change at T*, irrespective of the choice of Tₛₚₗᵢₜ. Additionally, 108 for Tₛₚₗᵢₜ=T* corresponds to the maximum likelihood-estimate in formula (3).

In some embodiments, a DRE-CUSUM estimator may be provided. For example, a time series may be split at Tₛₚₗᵢₜ and compute the DRE-CUSUM statistic as follows:

$${S}_{DRE}^{{T}_{split}} ( t ) = {\sum }_{i = 1}^{t} log ( \hat{ω} ( x ) ) , \qquad ( 10 )$$

where w(x) is an estimate of the density ratio which is obtained by density ratio estimation (DRE) models using samples from distributions P_{left} and P_{right}. A DRE-CUSUM estimator values may be obtained as follows:

$${\hat{T}}_{DRE - CUSUM} = {arg max}_{t} {S}_{DRE}^{{T}_{split}} ( t ) \qquad ( 11 )$$

Algorithm 1 below uses the DRE for unsupervised detection:

Algorithm 1
Unsupervised Single Change Point Detection using DRE-CUSUM.

```
Input time-series data: (x₁, x₂, .., x_{T}^, ..., xₙ)
1. Density Ratio Estimator (DRE) Training
$Divide the time ‐ series data at {T}_{split} ( say {T}_{split} = \frac{n}{2} ) to obtain ‐$
(i) X_{|1:T}_{ₛₚₗᵢₜ}_{-1|} ~ P_{left}, (ii) X_{|T}_{ₛₚₗᵢₜ}_{:n|} ~ P_{right}.
for number of epochs do
  a. Sample N₁,N₂ samples from P_{left}, P_{right}, respectively.
  b. Train DRE to determine ŵ(x), an estimate of the density ratio
  P_{left}(x)/P_{right}(x). (see Appendix C.)
end for
2. DRE-CUSUM based Change Detection
$a . Compute {S}_{DRE}^{{T}_{split}} ( t ) = {\sum }_{j = 1}^{t} log ( \hat{w} ( {x}_{j} ) )$
b. List the time instance \hat{T} (estimated change point) at which there is a
change in slope.
3. Verification Step
$Repeat steps 1 , 2 setting {T}_{split}^{′} = \hat{T} ( but not equal to \frac{n}{2} ) ,$
and find \hat{T}_{DRE-CUSUM} = arg maxₜ S_{DRE}^{T}^{ₛₚₗᵢₜ}^{′}(t). Verify that \hat{T} = \hat{T}_{DRE-CUSUM}
is the only slope change in S_{DRE}^{T}^{ₛₚₗᵢₜ}^{′}(t).
```

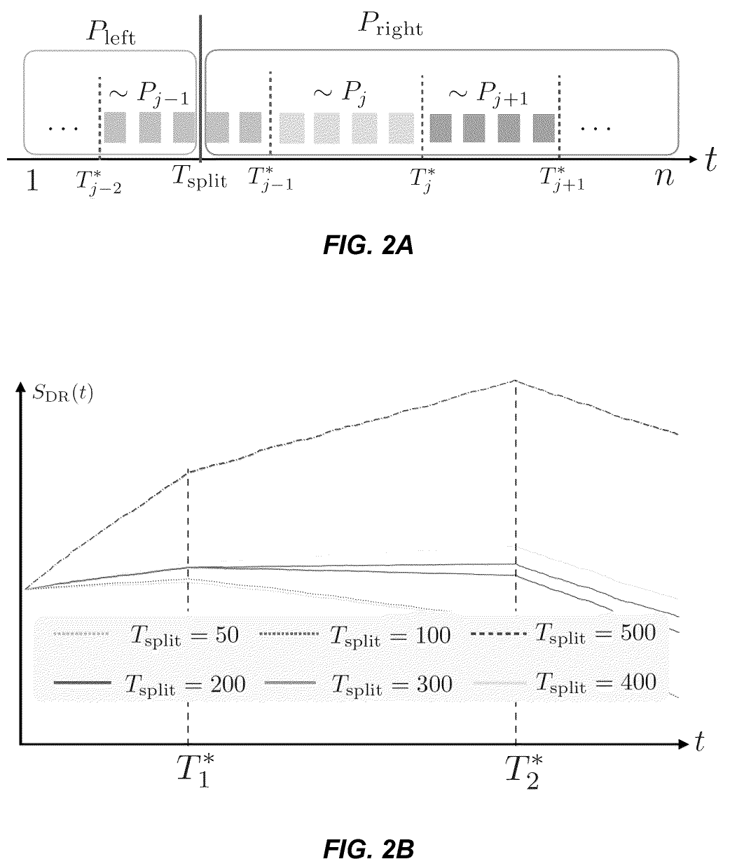

FIGS. 2A and 2B depict unsupervised multiple change detection statistics for different Tₛₚₗᵢₜ values. In FIG. 2A, multiple change point time-series data is depicted, where X[T*ⱼ₋₁:T*ⱼ]˜Pⱼ. In FIG. 2B, S_{DR}^{T}^{ₛₚₗᵢₜ} (t) vs t for 10-dimensional time-series of length 600 with two change points T₁=150, T₂=450. X_{[1,149]}, X_{[150:449]} and X_{[450:599]} follow multivariate gaussian distributions with mean vectors are sampled from Unif. [0, 0.4], Unif.[0.6, 1.0], and Unif.[1.6, 2.0], respectively, and identity co-variance matrix. For a time series, multiple change points may be denoted and have multiple sub-sequences. For example, a sub-sequence with sample may be drawn from an unknown distribution, such as Pⱼ for j−1, 2, . . . K (see FIG. 2A). A similar approach of splitting a time-series may follow by computing the DRE-CUSUM statistic that may be leveraged for detecting more than one change points. To provide the intuition behind this, consider any split point Tₛₚₗᵢₜ, and as before, suppose that the ratio P_{left}(x)/P_{right}(x). It can be readily shown that for every:

t∈⁻[T*ⱼ₋₁,T*ⱼ]⁻

the expected value of the log(⋅) of the density ratio is given as:

$${𝔼}_{{x}_{t}} [ log \frac{{P}_{left} ( {x}_{t} )}{{P}_{right} ( {x}_{t} )} ] = {\underbrace{KL ( {P}_{j} \vert \vert {P}_{right} ) - KL ( {P}_{j} \vert \vert {P}_{left} )}}_{= {Δ}_{j}}$$

As discussed herein, the slope of the DRE-CUSUM statistic will be proportional to the quantity Δⱼ≠Δⱼ₋₁ and Δⱼ≠Δⱼ₊₁ for all j=1, 2, . . . , K. Distinct slopes may be expected in the DRE-CUSUM statistic for each segment in the time-series. In FIG. 2B this behavior is shown for a synthetic 10-dim multivariate Gaussian time-series with two change points. The instances of the slope change are potential candidates for the estimated change points.

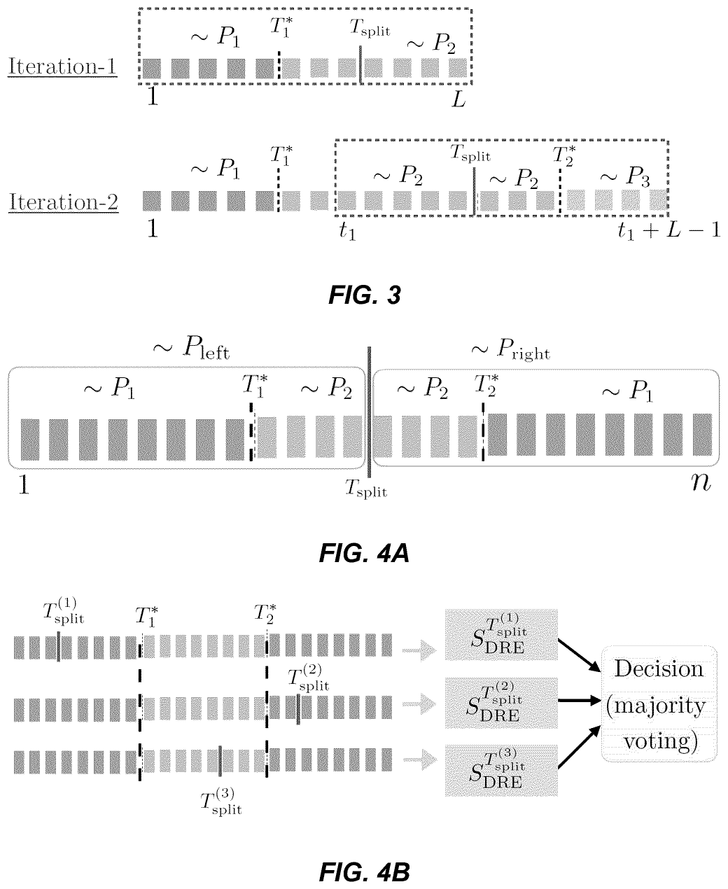

FIG. 3 depicts an online adaptation of DRE-CUSUM algorithm in accordance with one or more embodiments. In some embodiments, DRE-CUSUM may be readily applied for online change detection by recursively performing Steps 1-3 in Algorithm on real-time data. As shown in FIG. 3, a simple approach is to consider a window of length L (with L most recent samples collected). Steps 1-3 in Algorithm 1 can be performed on this window of L samples to determine all change points within this time interval. This window may be slid across the time series to consider new observations. A generalization of this approach is to use adaptive window sizes depending on past detected changes. Specifically, if changes, have been reliably detected in the previous window, then one only needs to keep the most recent samples from the past after the latest detected change point.

FIG. 4A shows an exemplary failure mode detection using a DRE-CUSUM when Algorithm 1 fails to detect the changes T*₁, T*₂ when P_{left}˜˜P_{right}. FIG. 4B depicts an exemplary computation of a DRE-CUSUM statistic for multiple Tₛₚₗᵢₜ values followed by a combined decision (e.g., majority vote). in accordance with one or more embodiments of the disclosed technology. In some embodiments, errors may be reduced in DRE-CUSUM. For example, failure modes of the DRE-CUSUM approach may be overcome as shown in the example of FIG. 4A. As shown in FIG. 4A, X_{[1:Tsplit-1]}˜P_{left}, and X_{[Tsplit:n]}˜˜P_{right}. If for a Tₛₚₗᵢₜ, it happens that P_{left}(x)˜P_{right}(x), ∀x, then as a consequence, the KL divergence KL(P_{left}∥P_{right}, ˜˜0. In such a scenario, the DRE-CUSUM statistic S_{DRE}(t) can fail to exhibit a slope change at the unknown change points. To alleviate this phenomenon, Algorithm 1 may be modified to consider multiple distinct Tₛₚₗᵢₜ as shown in FIG. 4B. For example, the DRE-CUSUM algorithm may be run for multiple distinct split points. The change points in the time-series may then be determined by applying a combined decision across the slope changes exhibited by the multiple DRE-CUSUM statistic(s). Some examples of the combined decision techniques that can be applied here are: (i) majority voting and (ii) weighted sum technique, wherein the weight corresponds to the probability that the slope change at a time instance corresponds to the true change point and is determined by the extent of the slope change. Furthermore, by using multiple values of Tₛₚₗᵢₜ, the change detection framework may be enhanced in Algorithm 1 through reduction in the detection errors (i.e. false alarms and mis-detections). Another refinement to Algorithm 1 may be to minimize the errors by searching for the best Tₛₚₗᵢₜ according to the proposed adaptive methods described herein. The subsequent Tit can be selected to maximize the value of the DRE-CUSUM statistic at time instances with a slope change.

Implementation examples of the disclosed provide: (i) the robustness of the DRE-CUSUM algorithm, (ii) the superiority of the DRE-CUSUM approach with other unsupervised techniques on both synthetic and real-world datasets, and (iii) capability of detecting changes in high-dimensional video datasets. Particularly, the experiments on the event detection in video frames highlight the key aspect that DRE-CUSUM is capable of demarcating the change points in very high-dimensional time-series data. Further, performance metrics are provided for evaluating DRE-CUSUM with other approaches, such as false alarm rate (FAR) and missed detection rate (MDR) which is computed as:

$$FAR = \frac{FP}{FP + TN} \qquad ( 12 )$$

$$MDR = \frac{FN}{FN + TP}$$

In some embodiments, a DRE may be modeled using kernels and deep neural networks (DNNs). For example, an embodiment of the disclosed may include a kernel-based DRE. For synthetic datasets, a 4-layered feed-forward neural network based DRE is used with a sigmoid, and softplus activations in the hidden, and final layers, respectively. For the change detection on video datasets, a 4-layered convolutional neural network, with sigmoid, and softplus activations used in the hidden layers, and final layer, respectively, may be used. To train a DRE, a wide variety of training objectives such as KLIEP and LSIF may be used.

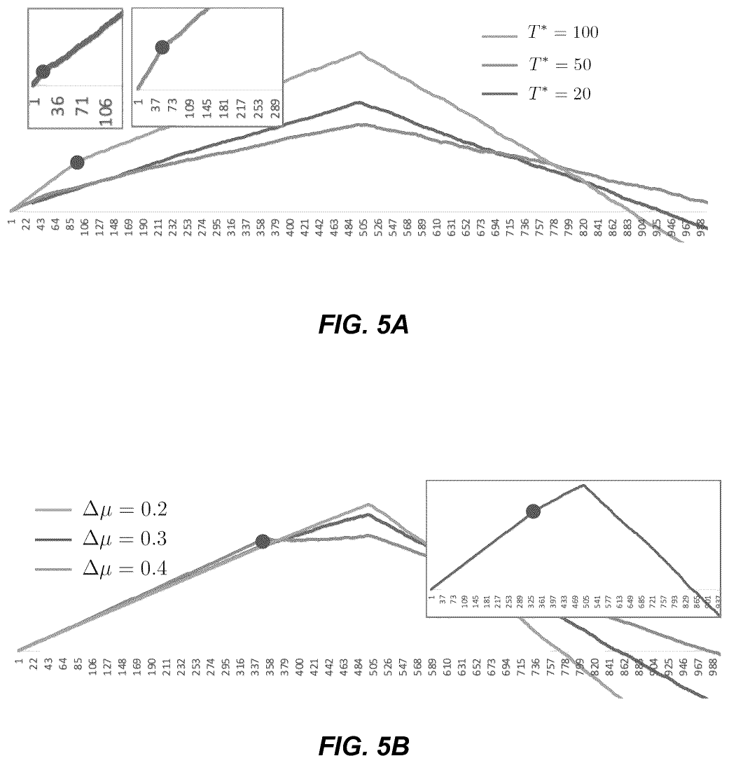

FIG. 5A depicts robustness of an exemplary DRE-CUSUM algorithm as described herein. Robustness is shown of DRE-CUSUM to |T*−Tₛₚₗᵢₜ|, and distance between pre-change (P₁) and post-change distributions (P₂). In this example, a 10-dimensional time-series data with 1000 samples whose pre- and post-change distributions are sampled from multivariate Gaussian distributions with mean shift at time T* is shown in FIG. 5A. Tₛₚₗᵢₜ is set to equal 500, the change point in the time series data T* is varied (e.g., 20, 50, 100), thereby, varying the number of points in the time-series sampled from distributions P₁ and P₂. From FIG. 5A, it is inferred that the DRE-CUSUM statistic changes slope at T* irrespective of |T*−Tₛₚₗᵢₜ|. For checking the robustnuess of DRE-CUSUM to distance between P₁ and P₂, consider 10-dimensional time-series data, with a mean shift at time-instance T*=350. P₁ and P₂ are multivariate Gaussian distributions with some covariance matrix. Set the mean variance to correspond to P₁ as shown in FIG. 5B and vary the difference between the change in variance. As shown in FIG. 5B, the slope of DRE-CUSUM statistic changes at T*=350 for a relatively small change in variance.

Table I shows a comparison of online DRE-CUSUM with Online BCD and Robust Online BCD. Segments may be sampled from uniform distributions. Results of DRE-CUSUM (online-variant) along with other approaches have been tabulated in Table 1, from which it can be inferred that DR-CUSUM (for KLIEP objective) outperforms Bayesian approach.

TABLE 1

| Methodology | FAR | MDR |
|---|---|---|
| DRE-CUSUM (DNN, KLIEP) | 0% | 0% |
| DRE-CUSUM (DNN, LSIF) | 0% | 14.3% |
| DRE-CUSUM (Kernel, LSIF) | 0.0005% | 14.3% |
| Online BCD | ~30% | ~0% |
| Robust Online BCD | 0.04% | 42% |

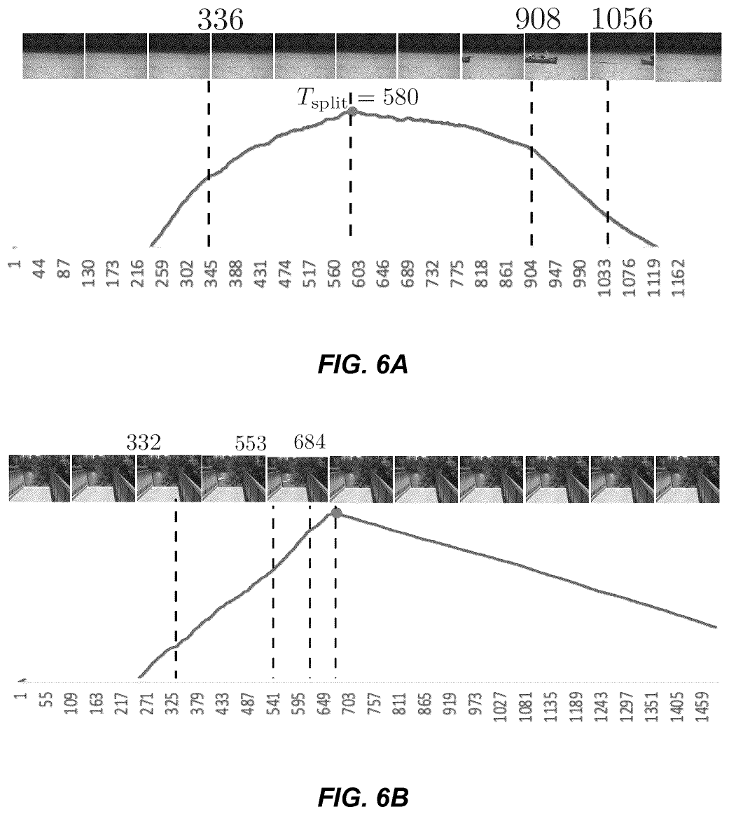

FIG. 6A depicts an exemplary process for video event detection using a DRE-CUSUM algorithm on real-world datasets. As shown in FIG. 6A, a canoe dataset is shown having a time-series that has 1,189 video frames. In this example Tₛₚₗᵢₜ=580. Frames 908 and 1,056 marks the entry and the exit of the boat, respectively. At the corresponding instances, slope changes are observed in the DRE-CUSUM statistic. On visual inspection, there are no significant changes at frame 336 (the slope change at t=336 in DRE-CUSUM is observed for different values of Tₛₚₗᵢₜ). The slope change at 336 may therefore be declared as a false alarm.

FIG. 6B depicts another exemplary process for video event detection using a DRE-CUSUM algorithm on a real-world dataset. As shown in FIG. 6B, a video of an overpass used as an example dataset. In this example, the time-series has 1500 samples, wherein Tₛₚₗᵢₜ=700. Slope changes present in DRE-CUSUM statistic around frames 553 and 684 corresponds to the object entry and exit frames, respectively. However, the slope change around the frame 332 is a false alarm.

DRE-CUSUM is a novel approach for unsupervised change detection and showed its broad applicability on a wide range of applications backed by theoretical guarantees and experimental results. The salient aspect of DRE-CUSUM is that it does not require any knowledge/specification of the underlying distributions, nor an estimate of the number of underlying change points, and is universally applicable for high-dimensional data.

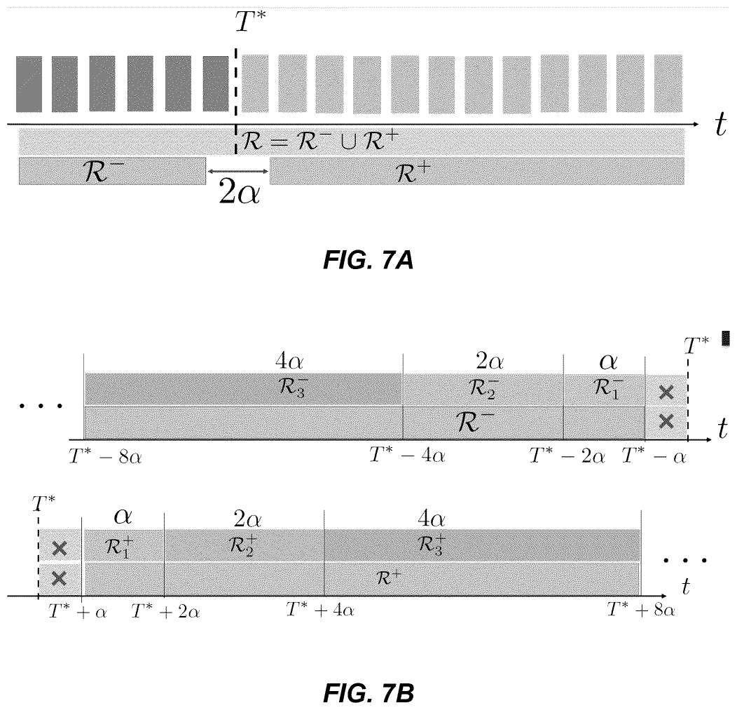

FIGS. 7A and 7B depict a region that may be split into a plurality of sub-regions. Each of the sub-regions may be further segmented into smaller regions, as shown in FIG. 1B. Regions may be segmented such that interval lengths double in length as the intervals move away from the change point, as shown in FIG. 7B. Assuming finite samples in the time-series data, the total number of intervals in R⁻ and R⁺ are:

$${log}_{2} ( \frac{{T}^{*}}{α} ) , and {log}_{2} ( \frac{n - {T}^{*}}{α} ) ,$$

respectively.

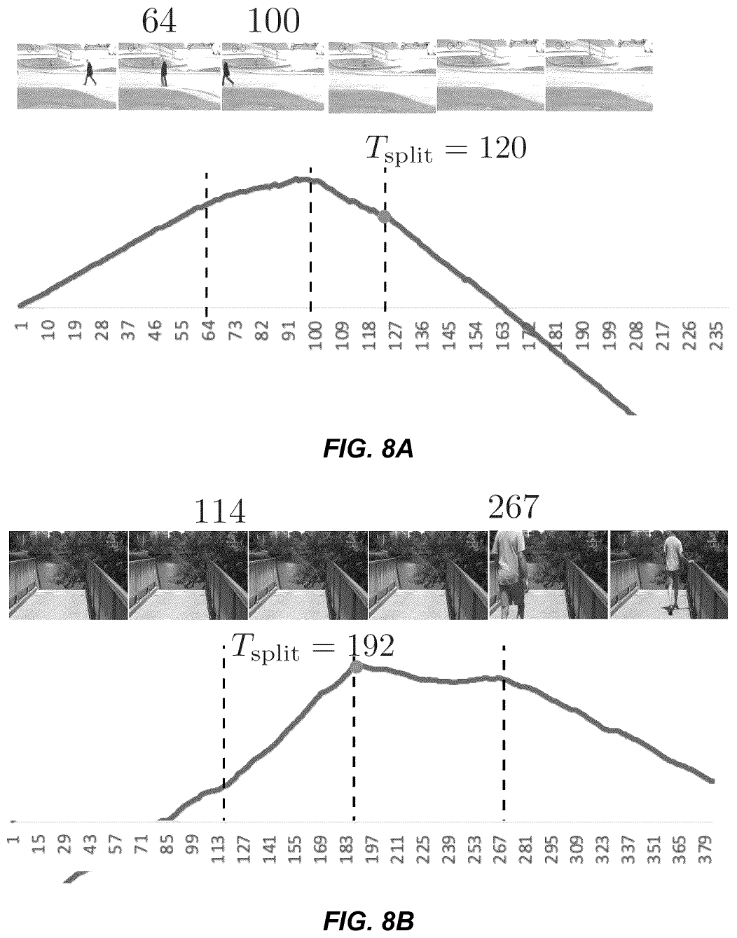

FIG. 8A depicts an exemplary process for video event detection within a pedestrian dataset using a DRE-CUSUM algorithm as described herein. In this example, the objective is to perform activity detection (in particular, detect the entry/exit of a person) in the sequence of video frames. In this example, with a time-series of 240 frames, a person is present in frames 0-100. As shown in FIG. 8A, Tₛₚₗᵢₜ=120. Slope changes are observed at frames 65 and 100. It may be noted that the video frames 65-100 belong to a transition period when a person gradually exists and is no longer present in the video. As can be observed, the DRE-CUSUM statistic is able to detect both the beginning and the end of the transition frames.

FIG. 8B shows an exemplary process for video event detection within an overpass dataset using a DRE-CUSUM algorithm described herein. For example, a time-series may have 385 frames. The person appears in the 260^{th} frame. Set Tₛₚₗᵢₜ=192 and obtain the corresponding DRE-CUSUM statistic as shown in FIG. 8B. Slope changes are observed at instances corresponding to frames 192 (i.e. Tₛₚₗᵢₜ), and 267. The slope change at around frame 120 corresponds to a false alarm (upon visual inspection no change is observed).

Additional architecture details for event detection is shown in Table II below. In the hidden layers of the convolutional neural network-based DRE, max-pooling may be applied and the KLIEP objective may be used to train the parameters of the neural network. In some embodiments, the neural network DRE may be trained for 2000 iterations.

TABLE II

| Experiment | DRE model | Architecture details |
|---|---|---|
| Synthetic | Feedforward | 4 dense layers |
| datasets | neural network | Hidden layer activation: Sigmoid |
| | DRE | Final layer activation: Softplus |
| Real-world | Kernel based | Kernel type: Gaussian |
| datasets | DRE | [8] |
| (USC, HASC) | | |
| Video | Convolutional | 4 convolutional layers |
| datasets | neural network | Hidden layer activation: Sigmoid |
| | DRE | Final layer activation: Softplus |

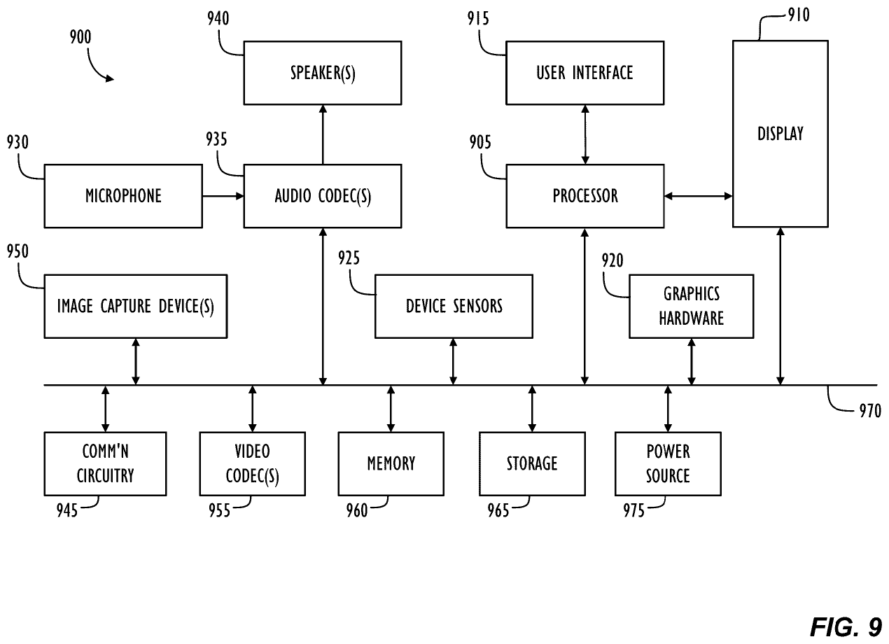

Referring now to FIG. 9, a simplified functional block diagram of illustrative multifunction device 900 is shown according to one embodiment. Multifunctional device 900 may show representative components, for example, for devices of an unsupervised change detection framework described herein. Multifunction electronic device 900 may include processor 905, display 910, user interface 915, graphics hardware 920, device sensors 925 (e.g., proximity sensor/ambient light sensor, accelerometer and/or gyroscope), microphone 930, audio codec(s) 935, speaker(s) 940, communications circuitry 945, digital image capture circuitry 950 (e.g., including camera system) video codec(s) 955 (e.g., in support of digital image capture unit), memory 960, storage device 965, and communications bus 970. Multifunction electronic device 900 may be, for example, a standalone PC or a personal electronic device, such as a personal digital assistant (PDA), personal music player, mobile telephone, or a tablet computer.

Processor 905 may execute instructions necessary to carry out or control the operation of many functions performed by device 900 (e.g., such as the detection of change using unsupervised techniques as disclosed herein). Processor 905 may, for instance, drive display 90 and receive user input from user interface 915. User interface 915 may allow a user to interact with device 900. For example, user interface 915 can take a variety of forms, such as a button, keypad, dial, a click wheel, keyboard, display screen and/or a touch screen. Processor 905 may also, for example, be a system-on-chip such as those found in mobile devices and include a dedicated graphics processing unit (GPU). Processor 905 may be based on reduced instruction-set computer (RISC) or complex instruction-set computer (CISC) architectures or any other suitable architecture and may include one or more processing cores. Graphics hardware 920 may be special purpose computational hardware for processing graphics and/or assisting processor 905 to process graphics information. In one embodiment, graphics hardware 920 may include a programmable GPU.

Image capture circuitry 950 may include two (or more) lens assemblies 980A and 980B, where each lens assembly may have a separate focal length. For example, lens assembly 980A may have a short focal length relative to the focal length of lens assembly 980B. Each lens assembly may have a separate associated sensor element 990. Alternatively, two or more lens assemblies may share a common sensor element. Image capture circuitry 950 may capture still and/or video images. Output from image capture circuitry 950 may be processed, at least in part, by video codec(s) 955 and/or processor 905 and/or graphics hardware 920, and/or a dedicated image processing unit or pipeline incorporated within circuitry 965. Images so captured may be stored in memory 960 and/or storage 965.

Sensor and camera circuitry 950 may capture still and video images that may be processed in accordance with this disclosure, at least in part, by video codec(s) 955 and/or processor 905 and/or graphics hardware 920, and/or a dedicated image processing unit incorporated within circuitry 950. Images so captured may be stored in memory 960 and/or storage 965. Memory 960 may include one or more different types of media used by processor 905 and graphics hardware 920 to perform device functions. For example, memory 960 may include memory cache, read-only memory (ROM), and/or random access memory (RAM). Storage 965 may store media (e.g., audio, image and video files), computer program instructions or software, preference information, device profile information, and any other suitable data. Storage 965 may include one more non-transitory computer-readable storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 960 and storage 965 may be used to tangibly retain computer program instructions or code organized into one or more modules and written in any desired computer programming language. When executed by, for example, processor 905 such computer program code may implement one or more of the methods described herein.

According to some embodiments, a processor or a processing element may be trained using supervised machine learning and/or unsupervised machine learning, and the machine learning may employ an artificial neural network, which, for example, may be a convolutional neural network, a recurrent neural network, a deep learning neural network, a reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

According to certain embodiments, machine learning programs may be trained by inputting sample data sets or certain data into the programs, such as images, object statistics and information, historical estimates, and/or image/video/audio classification data. The machine learning programs may utilize deep learning algorithms that may be primarily focused on pattern recognition and may be trained after processing multiple examples. The machine learning programs may include Bayesian Program Learning (BPL), voice recognition and synthesis, image or object recognition, optical character recognition, and/or natural language processing. The machine learning programs may also include natural language processing, semantic analysis, automatic reasoning, and/or other types of machine learning.

According to some embodiments, supervised machine learning techniques and/or unsupervised machine learning techniques may be used. In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. In unsupervised machine learning, the processing element may need to find its own structure in unlabeled example inputs.

The scope of the disclosed subject matter should be determined with reference to the appended claims, along with the full scope of equivalents to which such claims are entitled. In the appended claims, the terms “including” and “in which” are used as the plain-English equivalents of the respective terms “comprising” and “wherein.”

1. A system comprising:
a processor; and
a memory coupled to the processor and configured to store instructions for detecting a change in a time-series dataset, the instructions, when executed by the processor, configured to:
receive at least one time series dataset in which at least one deviation is present at a change point time;
train, using the at least one time series dataset, a density ratio estimator;
compute, using the density ratio estimator, a cumulative sum of likelihood ratio-based (DRE-CUSUM) statistic;
estimate the change point time from the DRE-CUSUM statistic; and
output a time value based on the estimated change point time.

2. The system of claim 1, the instructions further configured to:
identify deviations in statistical behavior of the at least one time series dataset.

3. The system of claim 1, the instructions further configured to:
generate an alert based on the outputted time value.

4. The system of claim 1, wherein the change point time is estimated based on a change in slope of the DRE-CUSUM statistic.

5. The system of claim 1, the instructions further configured to compute the DRE-CUSUM statistic by:
splitting the at least one time series data set at an arbitrary point; and
estimating a ratio of densities of distributing before and after the arbitrary point.

6. The system of claim 5, wherein the ratio of densities is estimated using a parametric model.

7. The system of claim 1, wherein the at least one time series dataset is a video file comprising a plurality of video frames.

8. A method for detecting a change in a time-series dataset, the method, with at least one computing device, comprising:
receiving at least one time series dataset in which at least one deviation is present at a change point time;
training, using the at least one time series dataset, a density ratio estimator;
computing, using the density ratio estimator, a cumulative sum of likelihood ratio-based (DRE-CUSUM) statistic;
estimating the change point time from the DRE-CUSUM statistic; and
outputting a time value based on the estimated change point time.

9. The method of claim 8, further comprising:
identifying deviations in statistical behavior of the at least one time series dataset.

10. The method of claim 8, further comprising:
generating an alert based on the outputted time value.

11. The method of claim 8, wherein the change point time is estimated based on a change in slope of the DRE-CUSUM statistic.

12. The method of claim 8, further comprising computing the DRE-CUSUM statistic by:
splitting the at least one time series data set at an arbitrary point; and
estimating a ratio of densities of distributing before and after the arbitrary point.

13. The method of claim 12, wherein the ratio of densities is estimated using a parametric model.

14. The method of claim 8, wherein the at least one time series dataset is a video file comprising a plurality of video frames.

15. A non-transitory computer readable medium comprising instructions for detecting a change in a time-series dataset, the instructions, when executed by a processor, implement a method comprising:
receiving at least one time series dataset in which at least one deviation is present at a change point time;
training, using the at least one time series dataset, a density ratio estimator;
computing, using the density ratio estimator, a cumulative sum of likelihood ratio-based (DRE-CUSUM) statistic;
estimating the change point time from the DRE-CUSUM statistic; and
outputting a time value based on the estimated change point time.

16. The non-transitory computer readable medium of claim 15, further comprising:
identifying deviations in statistical behavior of the at least one time series dataset.

17. The non-transitory computer readable medium of claim 1, further comprising:
generating an alert based on the outputted time value.

18. The non-transitory computer readable medium of claim 1, wherein the change point time is estimated based on a change in slope of the DRE-CUSUM statistic.

19. The non-transitory computer readable medium of claim 1, further comprising computing the DRE-CUSUM statistic by:
splitting the at least one time series data set at an arbitrary point; and
estimating a ratio of densities of distributing before and after the arbitrary point.

20. The non-transitory computer readable medium of claim 5, wherein the ratio of densities is estimated using a parametric model.
